(19) United States
(12) Patent Application Publication
(10) Pub. No.: US 2012/0319416 A1
(43) Pub. Date: Dec. 20, 2012

(54) Apparatus and Method For Gripping and Releasing Objects

(76) Inventors: Joseph D. Ellis, Charlotte, NC (US); Michael McEntire, Cornelius, NC (US)

(21) Appl. No.: 13/578,815

(22) PCT Filed: Mar. 16, 2010
(86) PCT No.: PCT/US10/27511

§ 371 Date: Aug. 13, 2012

(51) Int. Cl. B25J 15/06

(52) U.S. Cl. 294/183; 414/800; 901/40

(57) ABSTRACT

Improved devices and methods for gripping, supporting and releasing objects, which may be used with robotic arms, manipulators or vehicles, to hold, move or rotate objects in automated manufacturing, packaging, assembling and construction applications. The device comprises a body, an adapter flange for mounting an object gripper with an intake, a vacuum supply port, an airflow passageway configured to couple the intake to the vacuum supply port to define a substantially contiguous vacuum path, and an actuating system to open and close a breach in the substantially contiguous vacuum path. Admitting suction via the vacuum supply port while the breach is closed and the intake is in contact with the object produces a pressure gradient force having sufficient magnitude to support the object's weight in a gravitational field. Operating the actuating system to open the breach releases the object and preferably propels it away from the device.

### TECHNICAL FIELD

Certain embodiments of the present invention pertain generally to devices and methods for gripping and releasing objects. Some embodiments and variations, but not all embodiments and variations, pertain more specifically to end-of-arm tools, end effectors and heads for machines and vehicles, such as robotic arms, manipulators and cranes, and methods for using same to grip, lift and release objects.

### RELATED ART

Technology relevant to embodiments and variations of the present invention may be found in a wide variety of industries, including, for example, manufacturing, packaging, materials handling, food processing, assembly, construction, shipping, transportation, science, medicine and pharmaceuticals. In these and other industries, it is frequently necessary or desirable to grip, lift and/or move objects or materials without direct human contact with the objects because, for example, the objects need to be moved with speed, volume or precision that cannot be achieved or sustained by humans, because the objects are too heavy, inaccessible, hazardous or dangerous to humans, or because moving the objects by human labor is too expensive or unreliable.

In these situations, certain machines, such as robotic arms, manipulators and cranes, are employed to grasp, lift and move objects from one position or location to another position or location. Sometimes the objects are being picked up so they can be packed into commercial or retail packaging containers. In other situations, the objects are being loaded into or unloaded from vehicles, storage bins, cargo holds or shipping containers. In still other situations, the objects are being moved to a new location or position, or rotated in place, as an intermediate step in an automated manufacturing, assembling or shipping process, or as a step in a heavy construction project. In still other situations, it is necessary or desirable to temporarily grasp, secure and/or support the objects (e.g., to hold the objects in place so they do not fall to the floor or earth due to the force of gravity) while other objects, equipment, materials or instruments are moved into position nearby, moved out of the way, or used to perform a particular operation on the held or supported object.

The objects being picked up, secured and/or moved may include a broad range of items or materials having a wide variety of different sizes, shapes, weights and compositions, including without limitation, sealed or unsealed bags, pouches, envelopes, cans, bottles, boxes, drums, shipping containers, food items, pieces of fruit, vegetables, coins, pharmaceutical packages, electronic devices, computer equipment, furniture, machinery, stone, building materials, automobiles and automobile parts, to name but a few examples.

A manipulator is a device used under human control to manipulate objects or materials without direct human contact with the objects or materials being manipulated. A robotic arm is a robot manipulator, usually programmable, with functions similar to a human arm. In practice, the business ends of the robotic arms and manipulators are configured or adapted to receive and control a specialized tool, referred to as an “end-of-arm tool,” “end effector” or “head,” which may be especially adapted for performing some particular function, such as drilling, cutting, welding, spray-painting or lifting certain kinds of objects. Typically, although not necessarily, robotic arms and manipulators have a plurality of connected joints that permit the robotic arm or manipulator, not only to support the weight of the object, but to effect rotational motion, linear displacement, or both, on the end-of-arm tool, end effector or head, thereby causing the object held by the end-of-arm tool, end effector or head to be rotated and/or translated through space before it is released.

There are a number of technical problems associated with using conventional devices and methods for picking up, moving and releasing objects. First, conventional end-of-arm tooling devices, such as venturi suction devices with suction pads, are known to be unreliable and inefficient at holding, controlling and releasing certain types of objects during the high-speed accelerations and decelerations associated with high-speed picking and packing operations, like objects having recesses or grooves, irregularly shaped objects (e.g., fruits), porous objects, bagged objects (particularly where the bags have non-uniform protuberances, such as fin seals), and objects whose centers of gravity tend to shift during movement (e.g., liquid-filled objects). Another technical problem associated with conventional end-of arm tooling devices is that they typically depend on using gravity to release the object, or gravity in combination with reversing the flow of air through the device to produce a strong burst of positive air pressure (e.g., “blow-off”) to release the object, which tends to increase the time it takes to release the objects and thereby reduce the rate at which the conventional devices can operate effectively.

### SUMMARY OF THE INVENTION

As will be described in more detail below, embodiments and variations of the present invention address the above-described technical problems by providing improved devices and methods for gripping and releasing objects. One variation of the present invention provides an apparatus for gripping and releasing an object, comprising a body, an adapter flange for mounting an object gripper having an intake for making contact with the object, a vacuum supply port for admitting suction (negative air pressure) into the body, an airflow passageway configured to fluidly couple the intake on the object gripper to the vacuum supply port, thereby forming a substantially contiguous vacuum path between the intake and the vacuum supply port, and an actuating system operable to open and close a breach in the substantially contiguous vacuum path.

The vacuum supply port comprises a port, nozzle, bibb, valve or outlet configured to accept a hose or tube connected to a suction-generating device, such as a vacuum blower or pump, so that suction (i.e., negative air pressure) may be introduced into the airflow passageway in the body. When suction is admitted through the vacuum supply port while the breach in the substantially contiguous vacuum path is closed, a low pressure region is created just inside the intake, which causes the air in the higher pressure region just outside of the intake to move rapidly into that lower pressure region. When the intake is then brought into contact with the object to be gripped or picked up, the acceleration of air into the intake due to the pressure difference between the low pressure region and the high pressure region (i.e., the pressure gradient force) causes the object to be sucked into and pinned against the intake, whereby it can be supported against the force of gravity, picked up and/or moved to a different location. When the breach in the substantially contiguous vacuum path is opened, the pressure gradient force is sufficiently reduced or eliminated to release the object.

Depending on the application and the geometry of the objects to be gripped, the adapter flange may be configured to accept a number of different types of object grippers, including without limitation, suction pads, bag holders, vacuum pads, funnels, dishes, domes or bowls, and may also be configured to accept and hold multiple object grippers simultaneously. Regardless of the type and number of object grippers used, each object gripper will have an intake configured to make contact with the object. The intake is also configured to permit air to flow into the object gripper, although not necessarily while the intake is making contact with the object. Typically, although not necessarily, the adapter flange is movably attached to the body, and the object gripper will be fixedly mounted to the side of the adapter flange that is opposite from side that is adjacent to the body. It should be appreciated, however, that the object gripper itself may be a detachable and interchangeable component that may be manufactured, sold and/or installed separately from the body and adapter flange.

The substantially contiguous vacuum path comprises one or more airflow passageways, channels or voids in the body and/or the adapter flange, which, when the breach is closed, are aligned to be in fluid communication with each other, and fluid communication with the intake in the detachable object gripper, so as to permit air passing into the intake to pass into and through the body, and out of the vacuum supply port substantially uninterrupted by air flowing into the device by any other opening, such as the breach. Thus, when the breach is closed, most of the air passing through the body and out of the vacuum supply port due to the suction applied at the vacuum supply port will have entered the device through the intake on the object gripper, and not through some other opening in the device, such as the breach. In certain embodiments and variations of the invention, the substantially contiguous vacuum path may comprise a plurality of airflow passageways, which may be connected in series or parallel. Thus, the substantially contiguous vacuum path may comprise, for instance, a first airflow passageway through the object gripper, a second airflow passageway through the adapter flange, a third airflow passageway through the body, and a fourth airflow passageway through the vacuum supply port.

Although the adapter flange may comprise a hollow, circular or annular structure having its own passageways or channels through which the air leaving the object gripper flows before entering the airflow passageway in the body, embodiments and variations of the invention are not limited solely to devices having adapter flanges of this type and structure. Depending on the type and configuration of the adapter flange used, the substantially contiguous vacuum path may (or may not) be configured to channel air through an interior region of the adapter flange. Alternative adapter flanges having, for instance, a substantially solid structure arranged to hold the object gripper directly against the body so that the air passing out of the object gripper flows directly into an airflow passageway of the body without passing through a hole or gap in the adapter flange itself, may be substituted and used without departing from the scope of the claimed invention.

The actuating system in various embodiments of the present invention may be configured to open the breach in one or more of a number of different locations along the substantially contiguous vacuum path. In some embodiments, for instance, the actuating system comprises a set of mechanical, hydraulic and/or electrical components configured to open a breach anywhere between the intake and the vacuum supply port, such as in the body, the adapter flange or the object gripper. In other embodiments, however, the actuating system opens the breach between adapter flange and the body by urging the adapter flange, the object gripper, or both of them, away from the body, thereby physically decoupling the airflow passageway in the body from the object gripper and the intake.

As previously stated, the actuating system may be operated to close the breach in the substantially contiguous vacuum path, while suction is admitted into the airflow passageway in the body via the vacuum supply port. Thus, air entering the intake on the object gripper will be pulled through the intake, the object gripper, the body and the vacuum supply port, along the corridor provided by the substantially contiguous vacuum path, substantially without interruption or interference from air that did not enter the device through the intake. The volume and velocity of the suction applied at the vacuum supply port may be adjusted so as to produce about the area of the contact a pressure gradient force having a magnitude that is equal to or greater than, and opposite in direction to, the object's weight (i.e., the downward gravitational force exerted on the object by the earth's gravitational field), thereby counteracting the force of gravity and causing the object to be pinned against the intake on the object gripper. At this point, the object may be lifted, rotated or moved in space by lifting, rotating or moving the apparatus.

Operating the actuating system to open the breach permits air to pass into the device through the open breach and then directly into the airflow passageway in the body without first flowing through the object gripper. The additional volume of air passing into the airflow passageway from the open breach swiftly moves through the body to satisfy the negative air pressure forces created by the suction, effectively “short circuiting” the substantially contiguous vacuum path and substantially reducing or eliminating the flow of air through the intake on the object gripper. Consequently, the pressure gradient force that was produced about the area of contact between the object gripper's intake and the object when the breach was closed is substantially reduced or eliminated altogether. When the magnitude of the reduced pressure gradient force about the area of contact falls below the magnitude of the force of the object's weight, the object will fall away from the intake as a result of the force of gravity.

In applications where it is important that the apparatus be able to grip and release the objects at a high rate of speed, such as in an automated food packaging application, certain embodiments and variations of the present invention may include an actuating system configured to open the breach while simultaneously accelerating and decelerating the adapter flange, the object gripper, or both of them, in a manner that propels the object away from the object gripper, rather than relying solely on the force of gravity to dislodge and remove the object from the intake. Operating (or “firing”) the actuating system to push the object way from the object gripper while simultaneously breaching the vacuum path to cut the magnitude of the pressure gradient force saves a significant amount of time in automated high-speed packaging operations because it permits a computer-controlled robotic arm to start moving the end effector away from the release position and toward the next gripping position (i.e., toward the next object to be picked up) significantly sooner (measured in computer time) than it could start that movement if it is necessary to wait for the force of gravity to move the object out the path of the next movement of the object gripper.

As stated previously, a number of different types of actuating systems may be utilized to open and close the breach. In some embodiments, the actuating system is a mechanical system. In alternative embodiments the actuating system may comprise electronically-operated components. One exemplary mechanical actuating system comprises a piston cylinder in the body of the apparatus, a reciprocating piston slidably enclosed within said piston cylinder, a piston rod movably connecting the adapter flange to the reciprocating piston, a retracting port and an extending port. The retracting port comprises a hose or bib connection and fluid channels configured to admit a fluid, such as a gas or liquid, into one end of the piston cylinder to force the reciprocating piston to move toward the opposite end of the piston cylinder. Since the reciprocating piston is attached to the piston rod, and the piston rod is attached to the adapter flange, forcing the reciprocating piston to the opposite end of the piston cylinder causes the piston rod to pull the adapter flange toward the body, thereby closing the breach located between the body and the adapter flange. Closing the breach aligns the passageways in the body, adapter flange and object gripper so as to define the substantially contiguous vacuum path between the intake and the vacuum supply port.

The extending port comprises a hose or bib connection and fluid channels configured to admit a fluid, such as gas or liquid, into the end of the piston cylinder furthest away from the adapter flange, which forces the reciprocating piston away from that end, and causes the piston rod to urge the adapter flange away the body. Moving the adapter flange away from the body opens the breach located between the body and the adapter flange, and reduces the magnitude of the pressure gradient force about the area of the intake, which permits the downward pull of gravity to overcome the upward pull of the suction, thereby causing the object to fall away from the intake. If the adapter flange is accelerated away from the body at a high velocity and then the acceleration is suddenly halted, the corresponding motion of the object gripper attached to the adapter flange will propel the object away from the intake. It will be understood by those skilled in the art upon reading this disclosure that mechanical actuating systems may also be implemented using one or more shafts to drive cams to open and close the breach, rather than the piston and piston cylinder system described herein, without departing from the scope of the invention.

In another aspect of the present invention, there is provided a method for gripping and releasing an object using an apparatus comprising a body, an adapter flange attached to the body, an object gripper, mounted to the adapter flange, said object gripper having an intake configured to make contact with the object, a vacuum supply port, a vacuum path that permits air passing through the intake to flow into and through the body and the vacuum supply port, and an actuating system operable to open and close a breach in the vacuum path. This method comprises the steps of (1) admitting suction to the body via the vacuum supply port; (2) bringing the intake of the object gripper into contact with the object; (3) activating the actuating system to close the breach in the vacuum path, thereby producing about the area of the contact a pressure gradient force of sufficient magnitude to pin the object against the intake and support the object in a gravitation field; and (4) activating the actuating system to open the breach, thereby reducing the magnitude of said pressure gradient force by an amount sufficient to release the object.

This Summary is provided merely to introduce certain concepts and not to identify any key or essential features of the claimed subject matter. It is anticipated that certain embodiments of the present invention will be used as end-of-arm tools, end effectors or heads on robotic arms and manipulators. It is understood, however, that embodiments and variations of the present invention also may be beneficially used and practiced in connection with a wide range of other types of machines, vehicles and equipment, including without limitation hoists, cranes, tractor trailers, loaders, unloaders, automobiles, trucks, railroad cars, ships, aircraft, or any other mobile or stationary machine, vehicle or piece of equipment that can be used for gripping, lifting and/or or moving objects or materials without direct human contact with those objects or materials. The exact nature and configuration of the machine, vehicle or piece of equipment used in connection with devices and methods of the present invention will depend on the particular application or environment.

### BRIEF DESCRIPTION OF THE DRAWINGS

Exemplary and therefore non-limiting embodiments and variations of the present invention, and various aspects, features and advantages thereof, are explained in detail below with reference to and with the aid of the drawings, which constitute a part of this specification and include depictions of the exemplary embodiments. In these drawings:

FIGS. 1A, 2A and 3A show, respectively, a right perspective view (from above), a rear perspective view (from above), and a front perspective view (from below) of an apparatus according to one embodiment of the present invention with the breach closed (adapter flange retracted).

FIGS. 1B, 2B and 3B show, respectively, a right perspective view (from above), a rear perspective view (from above), and a front perspective view (from below) of an apparatus according to one embodiment of the present invention with the breach open (adapter flange extended).

FIGS. 4A, 4B and 4C show, respectively, a left side orthogonal view, a top side orthogonal view and a bottom side orthogonal view of an apparatus according to an embodiment of the present invention with the breach closed (adapter flange retracted).

FIG. 5A shows another right perspective view (from above) of an apparatus according to an embodiment of the present invention, wherein the body is depicted as transparent in order to more fully illustrate and describe some of the components (reciprocating pistons and piston rods) of an exemplary actuating system that can be used for opening and closing the breach (i.e., extending and retracting the adapter flange).

FIGS. 5B and 5C show, respectively, a top side orthogonal view and a right perspective view (from below) of the body with the top and bottom caps removed in order to more fully illustrate and describe some of the other components of the exemplary actuation system, including the piston cylinders and fluid channels.

FIGS. 6A, 6B, 6C and 6D show, respectively, a front perspective view (from above), a right side orthogonal view, a left perspective view (from below) and a right perspective view (from below), of an apparatus according to another embodiment of the present invention, wherein the object gripper mounted on the adapter flange comprises a single suction pad.

FIGS. 7A, 7B and 7C show, respectively, a right perspective view (from above), a left perspective view (from above) and a left perspective view (from below), of an apparatus according to yet another embodiment of the present invention, wherein the object gripper mounted on the adapter flange comprises a bag shoe.

FIGS. 8A and 8B show right perspective views (from slightly above) of an apparatus according to still another embodiment of the present invention, wherein the object gripper mounted on the adapter flange comprises a combination suction pad and bag shoe.

FIGS. 9A and 9B show left perspective views (from above and below, respectively) of an apparatus according to an alternative embodiment of the present invention, wherein the vacuum supply port is located on the top side of the body, rather than on front side of the body.

FIGS. 10A and 11A show, respectively, an exploded front perspective view (from below) and an exploded rear perspective view (from above) of an apparatus according to an embodiment of the present invention.

FIGS. 10B and 11B show unexploded views of the devices shown in FIGS. 10A and 11A.

FIGS. 12A and 12B show, respectively, front and left side sectioned views of an apparatus according to one embodiment of the present invention with the breach closed (adapter flange retracted).

FIGS. 12C and 12D show, respectively, front and left side sectioned views of an apparatus according to one embodiment of the present invention with the breach open (adapter flange extended).

FIGS. 13A, 13B and 13C show a schematic diagram illustrating a food packaging operation wherein flexible pouches of food are gripped, lifted, moved and released using a robotic arm and an exemplary embodiment of the present invention.

FIG. 14 shows a flow diagram illustrating the steps that may be performed in a process practiced in accordance with some embodiments of the invention.

FIGS. 15A and 15B show, respectively, a right perspective view (from above) and a right perspective view (from below), of yet another type of object gripper that may be used in connection with some embodiments and variations of the present invention, wherein the object gripper comprises a manifold adaptor and four suction pads.

### DETAILED DESCRIPTION OF EXEMPLARY EMBODIMENTS

Non-limiting examples of devices and methods arranged and configured to grip and release objects and materials according to certain embodiments and variations of the present invention will now be described in some detail by reference to the figures.

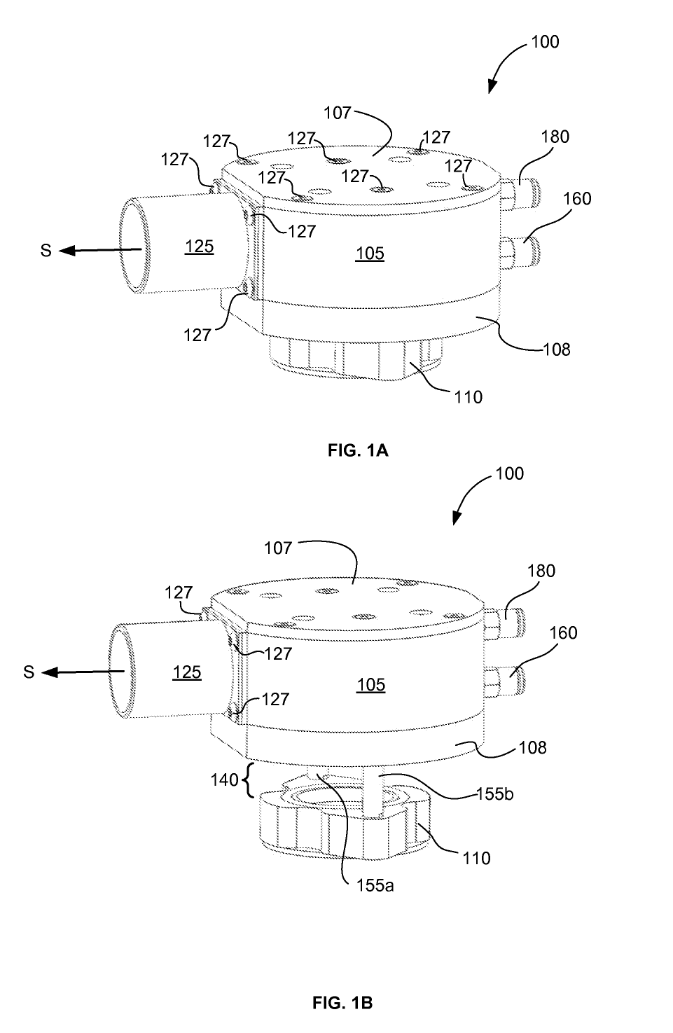

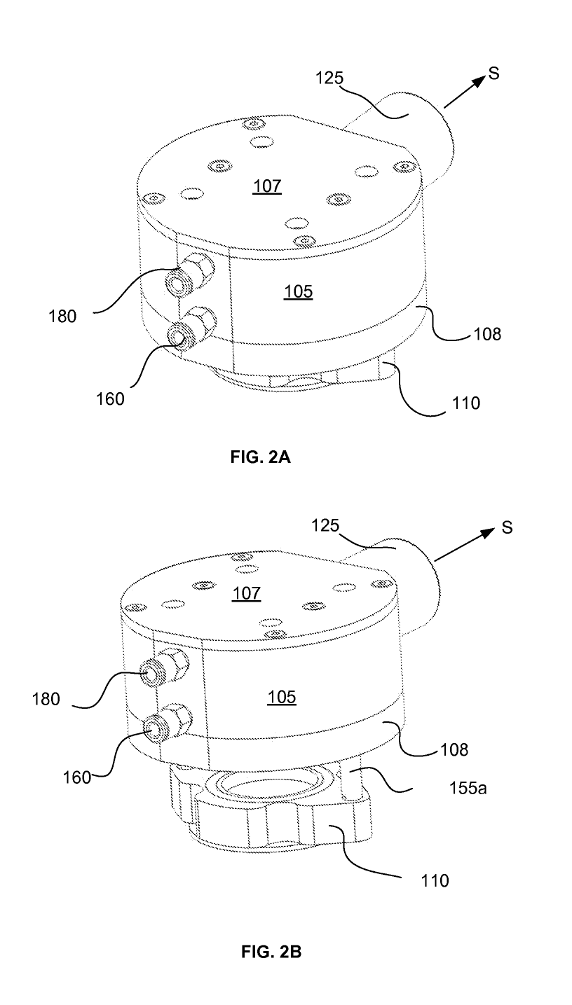

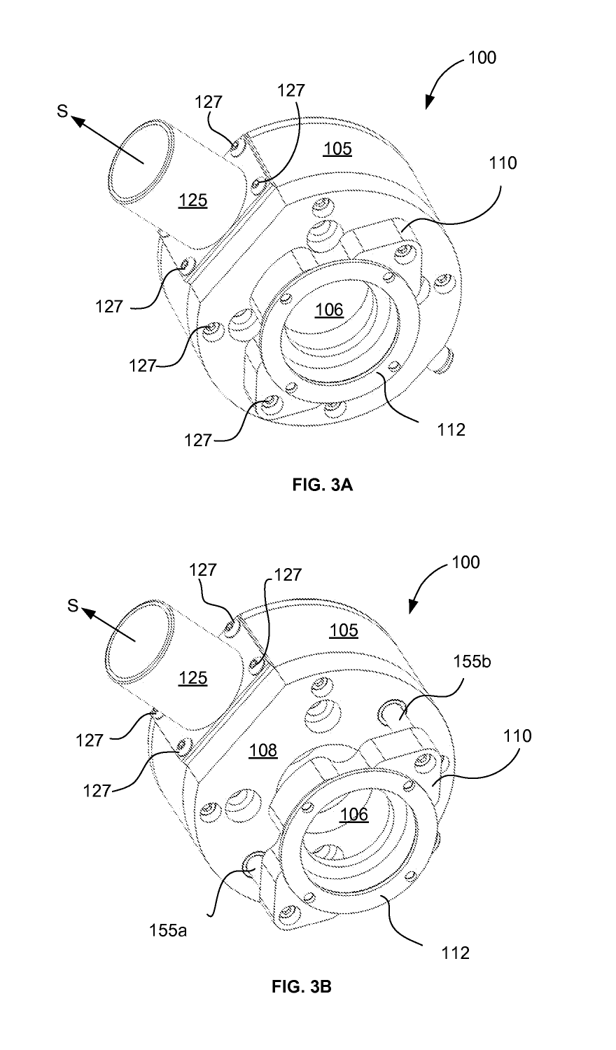

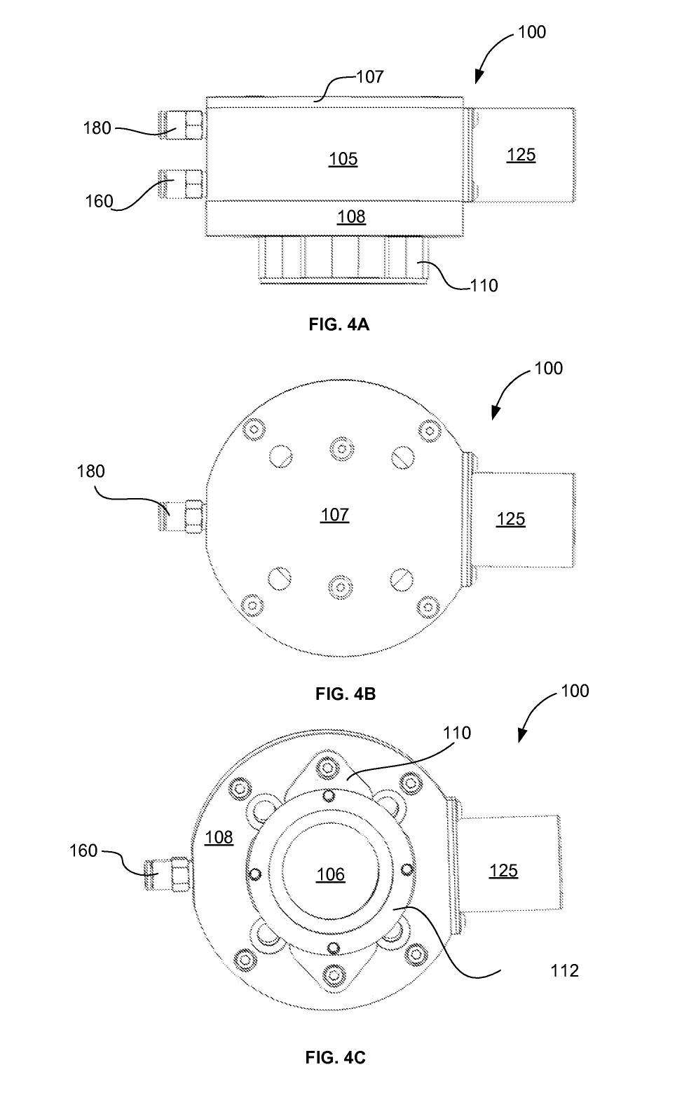

FIGS. 1A, 1B, 2A, 2B, 3A, 3B, 4A, 4B and 4C (referred to collectively as FIGS. 1A through 4C) show various views and positions of an exemplary end effector 100 arranged according to one embodiment of the present invention. Right perspective views (from above) of the exemplary end effector 100 are shown in FIGS. 1A and 1B, rear perspective views (from above) are shown in FIGS. 2A and 2B, and front perspective views (from below) are shown and FIGS. 3A and 3B. Left side, top side and bottom side orthogonal views of the exemplary end effector 100 are shown in FIGS. 4A, 4B and 4C, respectively.

As shown in FIGS. 1A through 4C, exemplary end effector 100 includes a body 105, an adapter flange 110, movably attached to the body 105, a vacuum supply port 125 for admitting suction to the body 105, a retracting port 160 and an extending port 180. Body 105 includes a top cap 107, a bottom cap 108, which are fastened to body 105 by fasteners 127. Vacuum supply port 125 is also fastened to body 105 with fasteners 127. It is understood, however, that top cap 107, bottom cap 108 and vacuum supply port 125 may be attached to body 105 using a variety of different types of fasteners or fastening methods, including without limitation, screws, bolts, nails, pins, clamps or solder. For clarity and ease of comprehension, however, not all of the fasteners depicted in FIGS. 1A through 4C are labeled.

Body 105 includes a retracting port 160 and an extending port 180, which are configured to accept hoses, tubes or pipes (not shown) connected to one or more fluid reservoirs (also not shown) containing fluid, such as gas or liquid, which can be admitted to body 105 through the retracting port 160 and the extending port 180 in order to retract and extend the adapter flange 110. As will be described in more detail below, retracting port 160 and extending port 180 are configured to deliver fluids into piston cylinders inside body 105 in order to move reciprocating pistons and piston rods 155a and 155b up and down, thereby retracting and extending the adapter flange 110. Body 105 also includes an airflow passageway 106 (best illustrated in FIGS. 4C, 5B, 5C, and 12A-12D), fluidly coupled to vacuum supply port 125, which permits air passing through a hole in the bottom cap 108 to pass through the body 105 and out of the vacuum supply port 125.

Vacuum supply port 125 preferably takes the form of a nozzle or bib adapted to receive a hose, tube or pipe (not shown), the other end of which is connected to a vacuum pump or blower (also not shown), which provides suction force S (i.e., negative air pressure) at the vacuum supply port 125 so as to pull air located in airflow passageway 106 out of the body 105. Although vacuum supply port 125 is shown in the drawings as a nozzle attached to and protruding from the body 105, it should be understood that alternative configurations for vacuum supply port 125, including, for instance, a bore hole, aperture, orifice, or other opening or slot, which penetrates the front, left, right, top, rear or bottom side of body 105, instead of protruding from it, may be employed to admit suction force S into the body 105 without departing from the scope of the invention. Likewise, retracting port 160 and extending port 180, shown in the drawings as jacks protruding from the body 105, may be alternatively arranged as bore holes, apertures, orifices, slots or other openings penetrating body 105.

Adapter flange 110 is movably attached to the body 105 by connection to piston rods 155a and 155b, extending from the bottom of body 105 and through bottom cap 108. In the exemplary embodiment of the end effector 100 shown in the drawings, the outer boundary of adapter flange 110 is cut into a substantially diamond-shaped structure in order to facilitate access to bore holes and fasteners securing the bottom cap 108 to the body 105, while the inner edge is defined by a circular hole that permits air to flow through the adapter flange 110 before passing through a hole in bottom cap 108 and into the airflow passageway 106 of body 105. The exact nature and shape of the adapter flange 110 is not critical to the scope of the invention, however, and will depend primarily on the particular method for fastening the bottom cap 108 to the body 105, as well as the particular shape of the object gripper used with the device. As shown best in FIGS. 3A, 3B, 4C and 10A, adapter flange 110 may include a gasket 112 configured to receive and secure an object gripper (not shown in FIGS. 1A through 4C) for making contact with the object or materials to be gripped and/or picked up by the device.

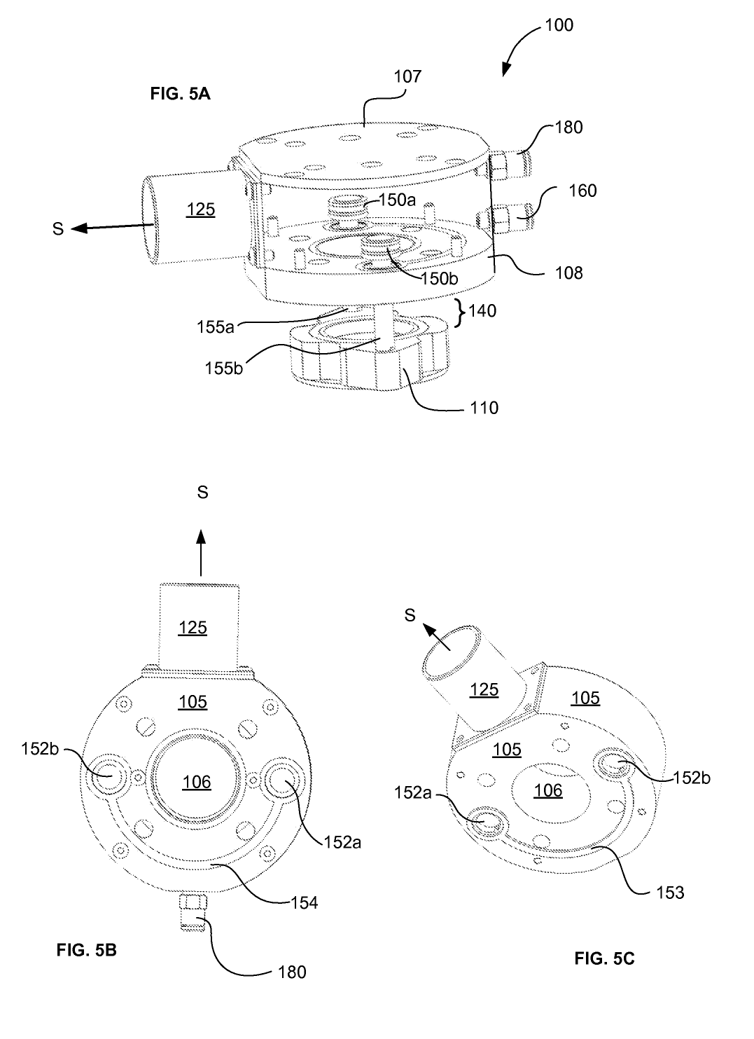

In order to more fully illustrate and describe some of the components of an exemplary actuating system that can be used for extending and retracting the adapter flange 110, FIG. 5A shows a right perspective view (from above) of the exemplary end effector 100, wherein the body is depicted as transparent, while FIGS. 5B and 5C show, respectively, a top side orthogonal view and a right perspective view (from below) of the body with the top cap 107 and bottom cap 108 removed. As shown in FIGS. 5A, 5B and 5C, the piston rods 155a and 155b, which attach the adapter flange 110 to the body 105, are connected at their other ends to reciprocating pistons 150a and 150b, respectively, which are movably enclosed within piston cylinders 152a and 152b bored through the body 105. Piston cylinders 152a and 152b are in fluid communication with retracting port 160 and extending port 180 via fluid channels 153 and 154, respectively, cut into the bottom and top regions of body 105. Retracting port 160 and extending port 180 are adapted to receive and hold hoses, tubes or pipes that carry fluids, such as air and water, into and out of the device.

To retract the adapter flange 110, retracting port 160 may be activated (or opened) to push fluid through fluid channel 153 and into the spaces in the piston cylinders 152a and 152b underneath the reciprocating pistons 150a and 150b, which causes the reciprocating pistons 150a and 150b to rise toward the top of piston cylinders 152a and 152b, thereby pulling piston rods 155a and 155b up into the body 105. As a result, adapter flange 110, which is attached to the reciprocating pistons 150a and 150b via piston rods 155a and 155b, is urged upward toward body 105 until the top side of adapter flange 110 abuts (or nearly abuts) the bottom side of bottom cap 108, which substantially or entirely occludes the breach 140 (best shown in FIGS. 1B and 5A). FIG. 4A, which shows a left side orthogonal view of exemplary end effector 100, illustrates the profile of the device when piston rods 155a and 155b are completely retracted into body 105, adapter flange 110 abuts bottom cap 108, and the breach 140 is closed. FIGS. 1A, 2A and 3A also depict various views of exemplary end effector 100 when the adapter flange 110 is retracted and breach 140 is closed.

To extend the adapter flange 110 and open the breach 140, extending port 180 may be activated (or opened) to push fluid through fluid channel 154 and into the spaces in the piston cylinders 152a and 152b above the reciprocating pistons 150a and 150b, which causes the reciprocating pistons 150a and 150b to fall toward the bottom of piston cylinders 152a and 152b, thereby pushing piston rods 155a and 155b out of the body 105. As a result, adapter flange 110 attached to the piston rods 155a and 155b is urged away from body 105, which opens the breach 140 that lies between body 105 and adapter flange 110 when piston rods 155a and 155b are in the extended position. This permits air to pass through the breach 140 and into airflow passageway 106 without first flowing through the annular-shaped hole through the adapter flange 110.

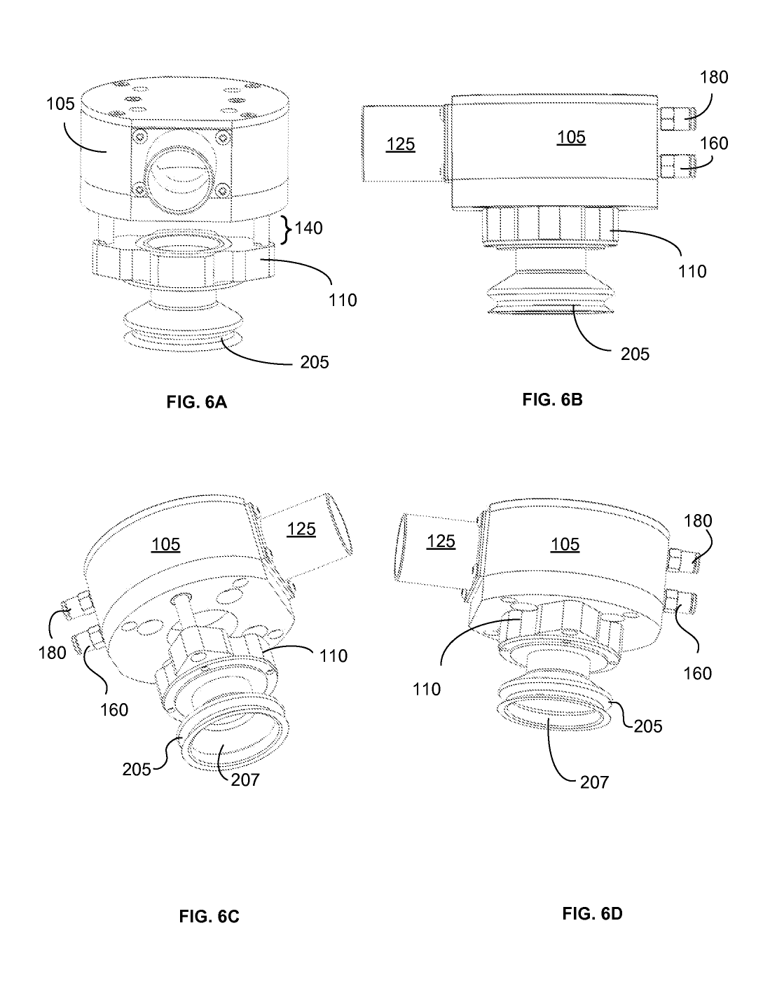

As previously stated, adapter flange 110 is preferably configured to receive and hold a variety of different types of detachable object grippers designed to make contact with the objects to be gripped. FIGS. 6A, 6B, 6C and 6D show, respectively, a front perspective view (from above), a right side orthogonal view, a left perspective view (from below) and a right perspective view (from below) of the exemplary end effector 100 with one example of such an object gripper. Specifically, as shown in FIGS. 6A-6D, a suction pad 205 (sometimes called a vacuum pad) is mounted on the distal end of adapter flange 110, opposite the body 105. It has been observed by the inventors that object grippers like suction pad 205, which has an intake 207 for making contact with the object to be gripped, works well for gripping, supporting and lifting objects having substantially solid and uniform shapes, as well as relatively rigid and non-porous surfaces. Non-limiting examples of objects this type of object gripper may be particularly well-suited to grip and lift may include, for instance, coins, hard plastic or metal boxes, steel girders, panes of glass, concrete slabs, books and bowling balls.

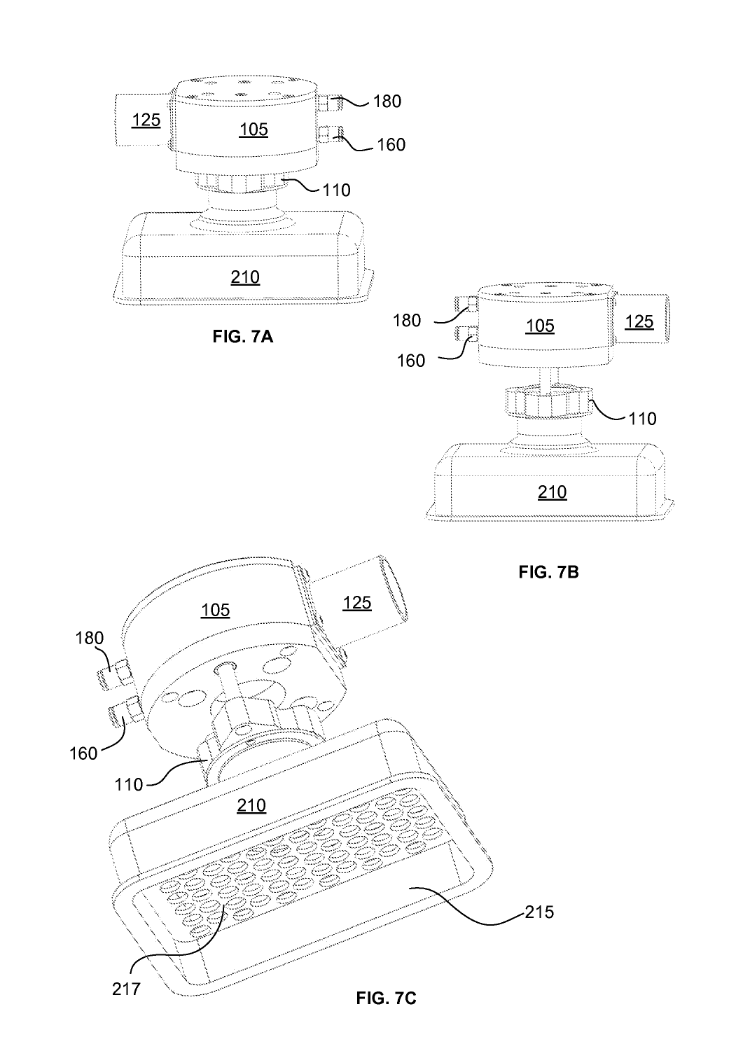

FIGS. 7A, 7B and 7C show, respectively, a right perspective view (from above), a left perspective view (from above) and a left perspective view (from below), of the exemplary end effector 100 with another type of object gripper attached to the distal end of the adapter flange 110. In this case, the object gripper comprises a bag shoe 210 having an intake 215. As shown best in FIG. 7C, the intake 215 for bag shoe 210 includes an optional filter 217 (e.g., a metal, plastic or wooden screen, grate or frame having a plurality of small holes) designed to permit air to flow into the bag shoe 210 while preventing objects larger than a certain size to move past the filter 217. Such optional filters may also be used in connection with the intakes on suction pad object grippers illustrated in FIGS. 6A-6D and discussed above. The inventors have observed that using object grippers like bag shoe 210 works well for gripping and lifting objects having substantially non-solid and non-uniform shapes, as well as relatively flexible and/or porous surfaces. Non-limiting examples of objects this type of object gripper may be particularly well-suited to grip, lift and release may include, for instance, plastic pouches of food, intravenous bags of liquid, pieces of fruit, paper or cardboard boxes, tablets, plastic bottles, pillows and bean bags, as well as objects having flanges, ridges, grooves or rabbets that would prevent a suction pad type of object gripper from forming an airtight seal therewith.

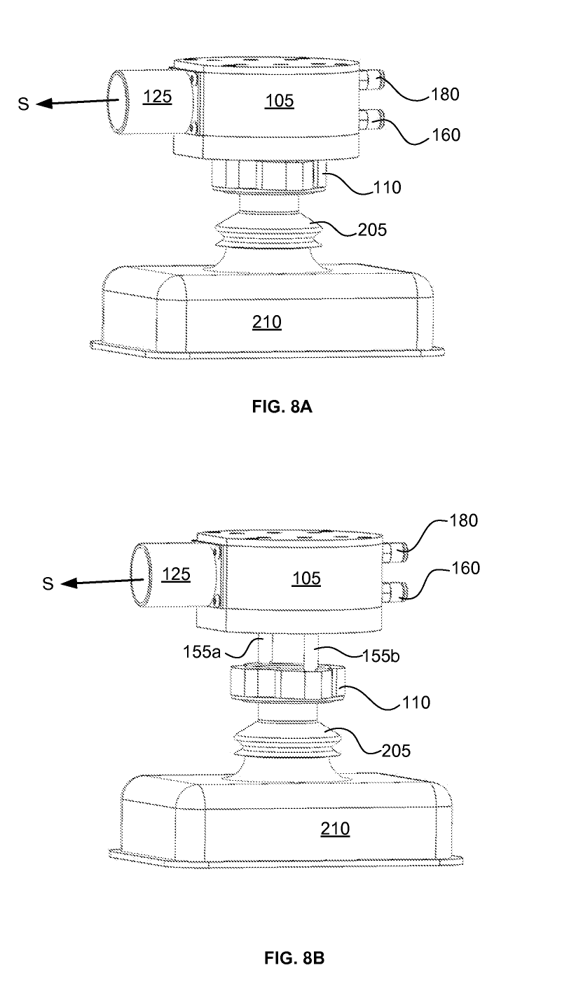

For certain applications or environments, it may be necessary, convenient or desirable to install and use two different types of object grippers simultaneously. FIGS. 8A and 8B show, for example, right perspective views (from slightly above) of the exemplary end effector 100, wherein the stem of the bag shoe 210 is inserted into the intake 207 of the suction pad 205. The end effector 100 is shown in the closed breach position (FIG. 8A) and the opened breach position (FIG. 8B). This configuration may be advantageous in applications where it is necessary or desirable to switch back and forth between using the bag shoe 210 and the suction pad 205.

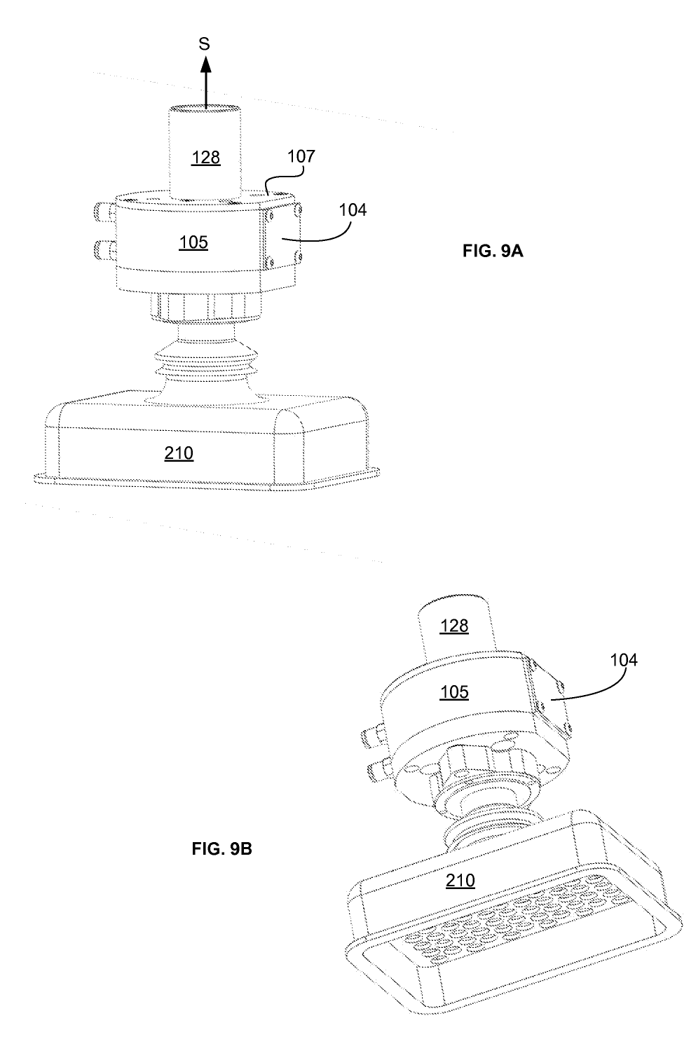

Depending, for example, on the weight of the objects to be picked up, the machine or vehicle to which the apparatus will be attached, or the number and angle of the arms and support members that need to be attached to the end effector, it may be necessary or desirable for certain embodiments of the invention to admit the suction through the top of the device, such as through the top cap 107, instead of admitting the suction through a side of the body. FIGS. 9A and 9B show left perspective views (from above and below, respectively) of an apparatus according to an alternative embodiment of the present invention, wherein the vacuum supply port 128 is located on the top side of the body 105, rather than on front. Like vacuum supply port 125 in the preceding figures, vacuum supply port 128 in FIGS. 9A and 9B is fluidly connected to airflow passageway 106 inside body 105 so as to permit air flowing through the body 105 (as a result of it being pulled by the suction) to pass out of the device via vacuum supply port 128. This configuration permits a robotic arm, machine, beam, boom or other support member (not shown) to be attached, for example, to the front face 104 of the body 105, instead of the top cap 107, and may also increase overall gripping power and/or speed of operation because air flowing through the device no longer needs to travel through an acute angle inside of the body 105. In certain applications and environments, it may also be necessary or desirable to use multiple vacuum supply ports, some of which may be located on top or in one side of the device while additional vacuum supply ports are located elsewhere. All of these modifications and variations on the placement and number of vacuum supply ports are understood to be within the scope of the claimed invention.

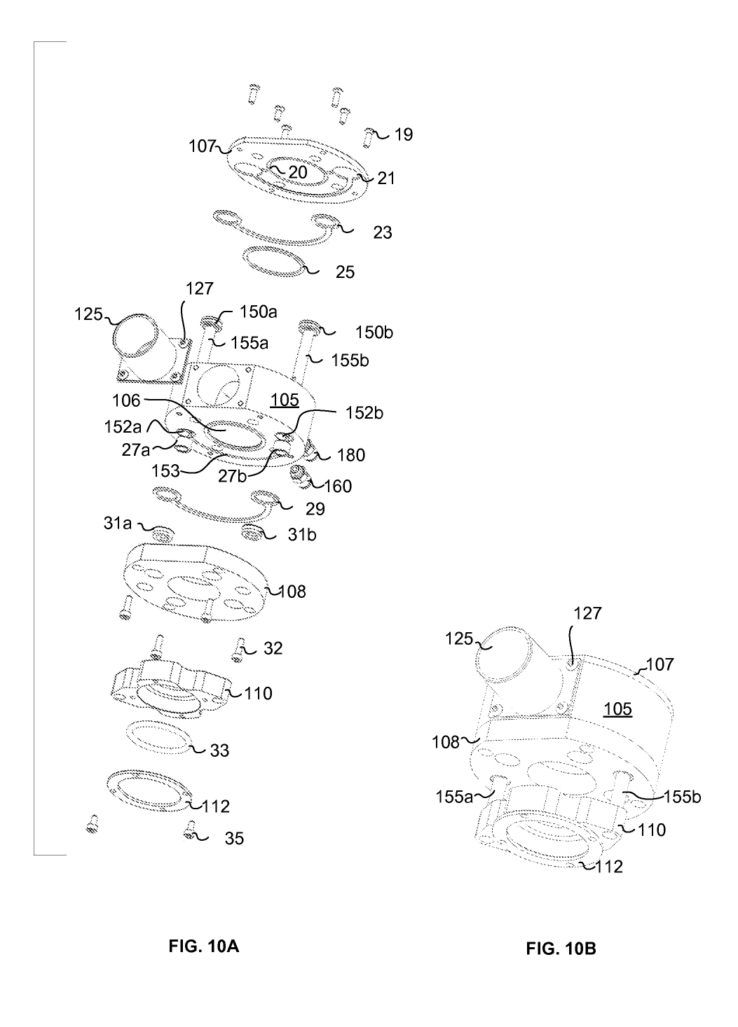

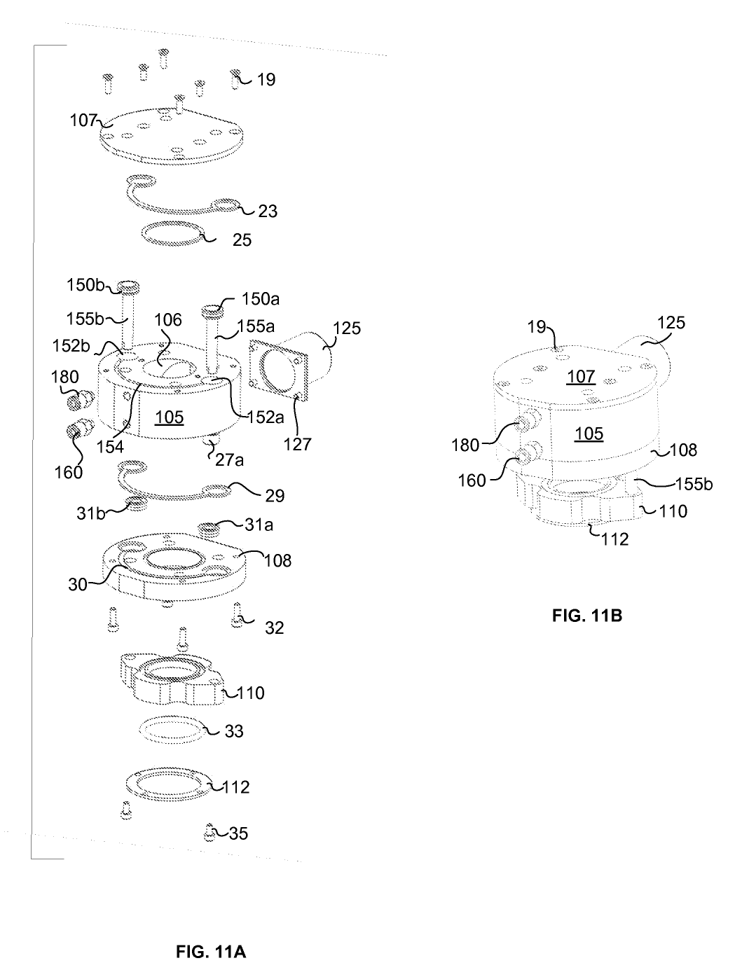

FIGS. 10A and 11A show, respectively, an exploded front perspective view (from below) and an exploded rear perspective view (from above) of the exemplary end effector 100. To enhance comprehension of the exploded views in FIGS. 10A and 11A, unexploded views of the same device from the same perspectives are provided in FIGS. 10B and 11B. Proceeding roughly from top to bottom, it can be seen from FIGS. 10A and 11A that the exemplary end effector 100 includes six socket countersunk head screws 19, which fasten top cap 107 to body 105. Top cap 107 has a gasket groove 20 and gasket groove 21, which are configured to receive and hold in place vacuum gasket 25 and fluid path gasket 23, respectively. Reciprocating pistons 150a and 150b are connected, respectively, to piston rods 155a and 155b, and inserted into piston cylinders 152a and 152b of body 105. Vacuum supply port 125, which is attached to body 105 by fasteners 127, is configured to admit suction into airflow passageway 106 of body 105. Retracting port 160 is operable to push a fluid, such as air, through fluid channel 153 and into piston cylinders 152a and 152b to retract piston rods 155a and 155b, while extending port 180 is operable to push fluid through fluid channel 154 and into piston cylinders 152a and 152b in order to extend piston rods 155a and 155b, thereby retracting and extending adapter flange 110 and opening and closing breach 140. Another fluid channel gasket 29 is held in place by gasket seat 30 carved into bottom cap 108. The retracting and extending motion of piston rods 155a and 155b back and forth through bottom cap 108 is supported by bushings 27a, 27b, 31a and 31b. Four socket head screws 32 fasten bottom cap 108 to body 105. An O-ring 33 is disposed between adapter flange 110 and gasket 112, which is fastened to adapter flange 110 with two socket head cap screws 35.

Constituent parts of embodiments and variations of the present invention may be made from a number of different materials, including without limitation aluminum, stainless steel, iron, brass, copper, plastic and rubber. It is recognized, however, that any number of relevant factors, including temperature, pressure, moisture, friction, strength, weight, durability, permeability, contamination, chemical reactivity, corrosion resistance, electrical conductivity, machine tooling, fabrication, cost, safety and regulatory considerations for the particular industrial application and environment where the device will be used, may lead skilled artisans and manufacturers to select, mix and use these materials or a variety of different materials, depending on need, without departing from the scope of the invention.

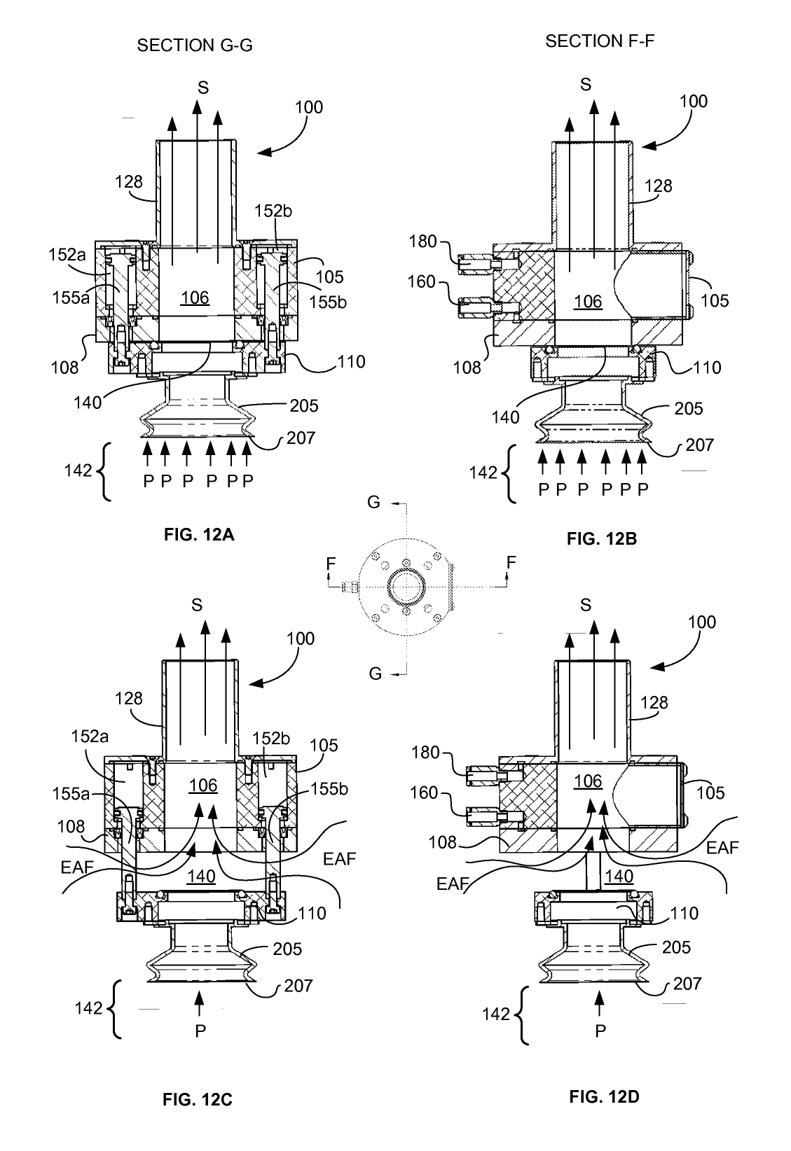

FIGS. 12A, 12B, 12C and 12D show sectioned (cut away) views of an exemplary end effector 100 configured to operate according to an embodiment of the invention. FIGS. 12A and 12B show, respectively, front and left side sectioned views of the end effector 100 with the breach 140 closed and adapter flange 110 refracted, while FIGS. 12C and 12D show, respectively, front and left side sectioned views of the end effector 100 with the breach 140 open and adapter flange 110 extended. In FIGS. 12A and 12C, the end effector 100 is sliced along the vertical plane (Section G-G) that intersects the piston cylinders 152a and 152b and piston rods 155a and 155b. In FIGS. 12B and 12D, the end effector is sliced along the vertical plane (Section F-F) that intersects the retracting port 160 and extending port 180. Therefore, viewed from a location above the top of the device, it can be seen that the plane defining Section G-G lies at a ninety degree angle from the plane defining Section F-F. All of the views show the exemplary end effector 100 with a suction pad object gripper 205 having an intake 207 configured for making contact with the objects (not shown).

Turning to FIGS. 12A and 12B, it is seen that end effector 100 includes a body 105, an adapter flange 110 for mounting an object gripper 205 having an intake 207 for making contact with the object (not shown). Adapter flange 110 is movably attached to the body 105 by its connections to piston rods 155a and 155b, which are attached to reciprocating pistons movably enclosed inside piston cylinders 152a and 152b of body 105. A vacuum supply port 128 extending from the top of the body 105 is provided for admitting suction S into the body 105. An airflow passageway 106 is configured to fluidly couple the intake 207 to the vacuum supply port 128, thereby defining a substantially contiguous vacuum path that permits air passing into and through the intake 207 to flow into and through airflow passageway 106 of the body 105 and then out of the vacuum supply port 128. The vacuum path is substantially contiguous because the adapter flange 110 is in the retracted position (i.e., butting the bottom face of bottom cap 108), which means the breach 140 located between the adapter flange 110 and the bottom cap 108 is closed. See FIGS. 12A and 12B.

The adapter flange 110 is moved into the retracted position (and breach 140 is closed) by operating the actuating system. Here, the actuating system comprises retracting port 160, extending port 180, reciprocating pistons 150a and 150b enclosed in piston cylinders 152a and 152b, piston rods 155a and 155b, and fluid channels 153 and 154, which are configured to transport fluids entering the retracting port 160 and the extending port 180, respectively, to the piston cylinders 152a and 152b. To close the breach 140, the retracting port 160 was opened to force fluid into the spaces in the piston cylinders 152a and 152b underneath the reciprocating piston heads 150a and 150b, thereby forcing the reciprocating pistons 150a and 150b toward the tops of the piston cylinders 152a and 152b, and drawing the piston rods 155a and 155b connected to the adapter flange 110 up into the body 105.

While the breach 140 is closed, substantially all of the air passing out of the vacuum supply port 128 must enter the device via intake 207 on the object gripper 205. As the magnitude of the suction S admitted to the vacuum supply port 128 increases, air is pulled through the substantially contiguous vacuum path with greater and greater force, thereby creating and multiplying the pressure gradient force P existing in the area 142, i.e., the area where the intake 207 is designed to come into contact with the object (not shown). Thus, when the intake 207 is moved into contact with the object, a step that is usually accomplished by moving the entire end effector 100 close to the object, the pressure gradient force P existing in the area 142 of the contact will urge the object against the intake 207. Provided that the suction S and the pressure gradient force P are raised to a magnitude that is equal to or greater than the weight of the object (i.e., the downward force earth's gravity exerts on the object's mass), the object will be pinned against the intake 207 by the pressure gradient force P, and will stay pinned against the intake 207 of object gripper 205 while the end effector 100 is lifted and/or other equipment or supports holding up the pinned object are removed. Provided that the pressure gradient force P is raised to a magnitude that is sufficient to overcome both gravity and any acceleration and deceleration forces caused by moving and/or rotating the object in space, moving and rotating the end effector 100 while the object is pinned to the intake 207 by the pressure gradient force P will cause the object to be moved and/or rotated without dislodging it from the intake 207.

Accordingly, it can be seen that the magnitude of the suction force S and the magnitude of the pressure gradient force P required to grip, support, lift, move or rotate the object will depend on the object's weight, the speed at which the object is lifted, moved and/or rotated, the strength of the gravitation field, as well as the buoyancy of the medium in which the object is located. Typically, the more the object weighs (or the greater its mass) the more suction S will be required to produce a pressure gradient force of sufficient magnitude to lift and/or move the object using the device. But if the operation is taking place while the object is located, for instance, in a liquid, or in a low- or high-gravity environment, then the magnitude of the suction S, and the magnitude of the pressure gradient force P required to move and/or lift the object will vary accordingly. Under these circumstances, the magnitude of the suction S applied to the vacuum supply port can be adjusted to achieve the optimum level of support and control over the object.

FIGS. 12C and 12D show sectioned (cut away) illustrations of exemplary end effector 100 with the adapter flange 110 in the extended position and the breach 140 open. Opening the breach 140 and extending the adapter flange 110 is accomplished, in the exemplary embodiment, by operating (i.e., opening) the extending port 180 to force fluid, such as air or water, into the spaces in the piston cylinders 152a and 152b above the reciprocating pistons 150a and 150b, thereby forcing the reciprocating pistons downward, which pushes the piston rods 155a and 155b out of the body 105.

As can be seen in FIGS. 12C and 12D, opening the breach 140 permits a relatively large volume of exterior air that has not flowed through the object gripper 205 to surge into and through the breach 140 and enter the airflow passageway 106 in response to the suction force S applied at the vacuum supply port 128. The large volume of exterior air surging into the airflow passageway 106 through the breach 140 substantially satisfies the vacuum effect (i.e., pressure gradients) existing in airflow passageway 106 due to the suction S. (The path of the exterior air flow into the breach is represented in the figures by the arrows designated EAF). Accordingly, opening the breach 140 will cause a significant drop in the volume of air being pulled into the airflow passageway 106 from the object gripper 205 and the intake 207. Although some small volume of the air passing into the airflow passageway 106 while the breach 140 is open may still have entered the device through the intake 207, rather than the breach 140, it will not be enough volume to sustain a high magnitude pressure gradient force P in the area 142 of the contact with the object. When the magnitude of pressure gradient force P pulling up on the object to pin it against the intake 207 drops below the magnitude of the force of gravity pulling down on the object, the force of gravity will once again assert control over the object to dislodge it from the intake 207 and release it from the device.

Although the breach 140 is shown and described herein as a space between an airflow passageway in the adapter flange 110 and a corresponding airflow passageway 106 in the body 105, it is noted that the breach may take some other form without departing from the scope of the invention, including without limitation a gap, aperture, slot, entrance, cavity, cutout, foramen, groove, hole, hollow, opening, orifice, separation, wicket, or any other kind of void in the vacuum path that can be closed, blocked, joined, covered, obstructed or shut. It is also noted that the breach may be located in or between other regions and components of the substantially contiguous vacuum path. Thus, the breach may be situated, for example, in the vacuum supply port, in the body, in the object gripper, or anywhere between these components. Multiple breaches may also be employed to short circuit the substantially contiguous vacuum path.

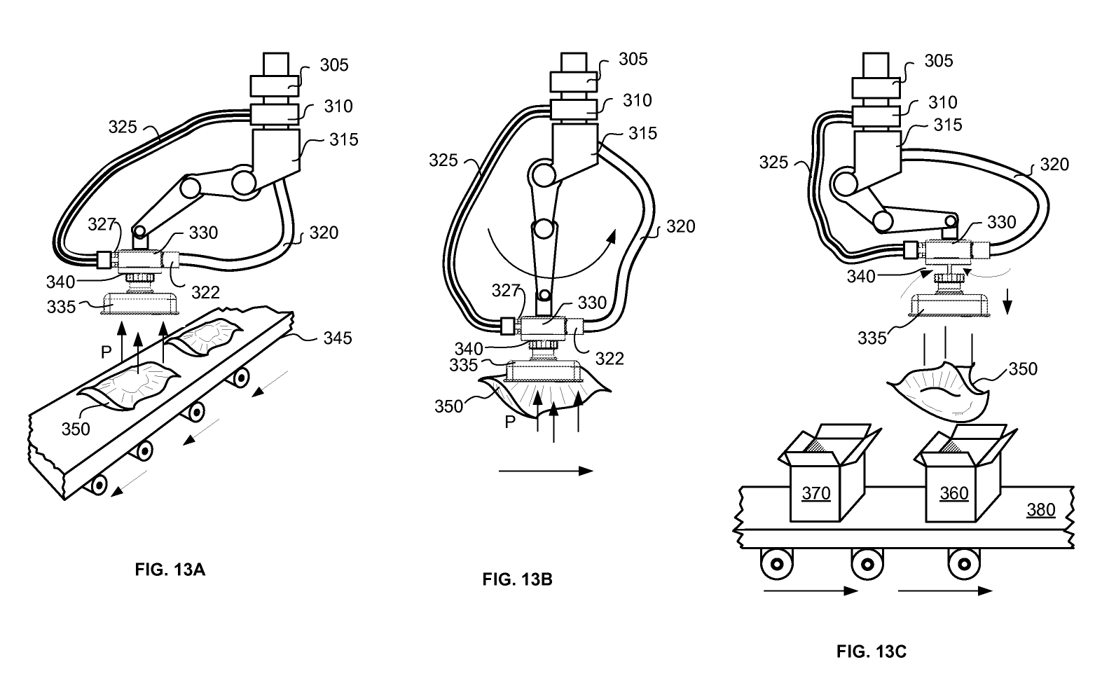

FIGS. 13A, 13B and 13C show a schematic diagram illustrating a food packaging operation wherein flexible pouches 350 moving along a conveyor 345 are gripped, lifted, moved and released into boxes 360 and 370 moving along another conveyor 380 using a robotic arm 315 and an exemplary end effector 330 according to an embodiment of the present invention. As shown in FIGS. 13A-13C, end effector 330 is attached to the business end of robot arm 315. A bag shoe 335, suitable for gripping and releasing flexible objects, such as flexible pouch 350, is attached to the adapter flange on end effector 330, opposite the connection to robot arm 315. A vacuum tube 320 is connected at one end to the vacuum supply port 322 on the side of the body of end effector 330. The other end of vacuum tube 320 is connected to a vacuum blower or pump (not shown). Fluid tubes 325 carry fluid, such as air or water, from fluid reservoir 310 to the retracting and extending ports 327, which may be activated to open and close breach 340 between the end effector 330 and the bag shoe 335. Initially, as shown in FIG. 13A, the breach 340 of end effector 330 is closed.

The robot arm 315 and retracting and extending ports 327 are controlled by a robot controller 305, comprising one or more memory devices and microprocessors. The memory devices are encoded with program instructions that, when executed by the microprocessor, cause the microprocessor to perform a variety of functions, including moving the robot arm (and therefore the end effector 330) to a first location over conveyer 345 to bring bag shoe 335 into contact with flexible pouch 350, and moving the robot arm 315 and end effector 330 to a second location over box 360 to release them. Preferably, but not necessarily, robot controller 305 also contains program instructions and routines for activating the retracting and extending ports 327 to open and close the breach 340 at the appropriate points in time, as well as program instructions and routines for activating and deactivating the vacuum blower or pump (not shown) supplying suction to vacuum supply port 322 via vacuum tube 320.

It is noted that the robot arm 315 of FIGS. 13A-13C is provided for illustration only and that, while the robot arm 315 is shown having parallel axes of movement, those skilled in the art will understand that a suitable articulated robot arm would typically have at least three differently arranged axes, depending on the application, the geometry of the objects to be picked up, and the distance between the locations for picking up the objects and releasing them. Examples of suitable robot arms for use with embodiments of the present invention include without limitation, Selective Compliant Articulated/Assembly Robot Arms (SCARA) and Cartesian coordinate robots. Suitable robotic arms and robot controllers for use with embodiments of the present invention may include, for example, the Quattro 4 Axis Picker, the Delta 3 Axis Picker, which may be obtained from Adept Technology, Inc., of Pleasanton, Calif., USA (www.adept.com). Articulated robotic arms suitable for use with the present invention may also have as many as five or more different axes.

As shown in FIG. 13A, robot controller 305 causes robot arm 315 to move end effector 330 over conveyor 345 and lowers it so that bag shoe 335 comes into contact with fluid pouch 350. While the bag shoe 335 is in contact with flexible pouch 350, suction is supplied at vacuum supply port 322 via vacuum tube 320, which, so long as breach 340 is closed, produces a pressure gradient force P about the area of the contact between the bag shoe 335 and the flexible pouch 350. The suction supplied at vacuum supply port 322 is set at a volume and velocity to produce a pressure gradient force P that has a magnitude sufficient to pin the flexible pouch 350 against the intake on bag shoe 335 and support its weight in a gravitational field. Typically, bag shoe 335 will have a grate or screen positioned over or within its intake so as to permit air to flow into the intake around flexible pouch 350 without permitting flexible pouch 350 to pass therethrough.

As shown in FIGS. 13B and 13C, robot controller 305 then causes robot arm 315 to rise and rotate so that the end effector 330, bag shoe 335, and flexible pouch 350 pinned to bag shoe 335, are translated through space to a new position over box 360 on conveyor 380. When flexible pouch 350 is positioned over packing box 360, the extending port 327 is activated to open the breach 340 by urging the adapter flange holding the bag shoe 335 away from the body. (See FIG. 13C). When the breach 340 is opened, external air immediately flows into the body of end effector 330 through the breach 340, which reduces the magnitude of the pressure gradient force P so that it can no longer support the weight of flexible pouch 350 against bag shoe 335. As a result, the force of gravity on the flexible pouch 350 (i.e., its weight) begins to pull the flexible pouch 350 away from bag shoe 335 and toward packing box 360.

When the breach is opened, it takes a finite amount of time for the magnitude of the pressure gradient force P to fall to a level that is equal to or less than the magnitude of the force of gravity on the flexible pouch 350. Therefore, it is expected that there will be a short time delay between the time that the breach is opened and the time the force of gravity can overcome the falling magnitude of the pressure gradient force P and pull the flexible pouch 350 clear of the bag show 335. In these situations, the robot controller 305 may be programmed to wait a moment or two for the flexible pouch 350 to fall clear of the walls of the bag shoe 335 before causing the robotic arm 315 to move end effector 330 and bag shoe 335 away from the position it is in when the breach is opened. Without this pause, it is likely that the walls of the bag shoe 335 could strike flexible pouch 350 as it falls away from the intake, thereby knocking it away from its intended destination in packing box 360.

Although each slight delay inserted between the time the breach is opened and the time the end effector 330 and bag shoe 335 can be moved into its next cycle may be practically imperceptible on a human time scale, such programmed delays could add up to a considerable amount of wasted time and lost productivity over a period of hours, days or weeks. In situations where the goal is to move and pack as many flexible pouches as possible in a given time period, the wasted time and lost productivity may be unacceptable. To address this problem, certain embodiments of the present invention may configured to open the breach 340 in a manner that causes the adapter flange and the bag shoe 335 to momentarily accelerate away from the body of the end effector 330 with sufficient speed and force to accelerate the motion of the flexible pouch 350 downward, thereby propelling the flexible pouch 350 away from the bag shoe 335. Thus, the flexible pouch 350 begins moving toward the box 360 simultaneously with the opening of the breach 340, and consequently, starts moving toward the box 360 even before the pressure gradient force P falls to a magnitude low enough to permit gravity to act on the flexible pouch 350, thereby affecting a quicker release of the product. This quick release permits the robot controller 305 to be programmed to start moving the robot arm 315, end effector 330 and bag shoe 335 away from the release position that much sooner, without having to wait for the effect of gravity to pull the flexible pouch 350 down and out of the intended path of the side walls of the bag shoe 335. Because the robot arm 315 can start moving into its next cycle sooner, a considerable amount of time is saved for each cycle and many more objects can be moved over a given time period. Accordingly, the quick release function may permit packing a larger number of objects in a given time period using a fewer number of robotic packaging machines.

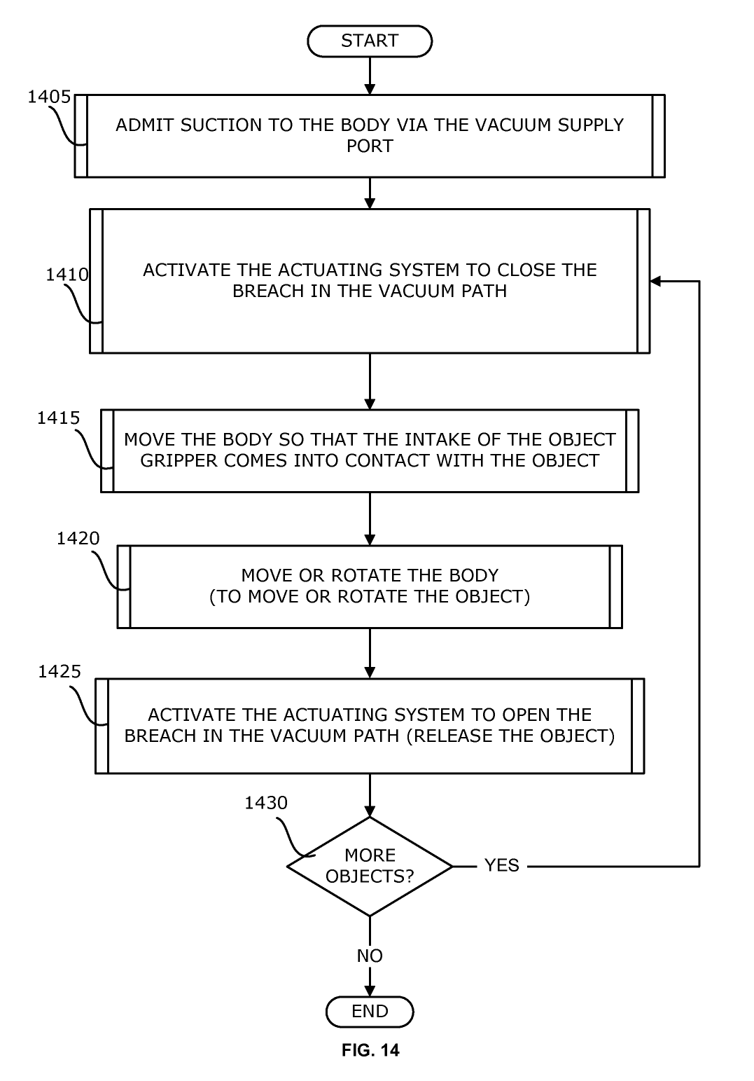

FIG. 14 shows a flow diagram illustrating the steps a system like the one described above with reference to FIGS. 13A, 13B and 13C, may perform in accordance with some embodiments of the invention, to grip, move (or rotate) and release objects. As shown at steps 1405 and 1410 in FIG. 14, the first steps comprise admitting suction to the body of the end effector via the vacuum supply port and activating the actuating system to close the breach in the vacuum path. The third step (step 1415 in FIG. 14) is to move the body of the apparatus so that the intake on the object gripper comes into contact with the object to be picked up. It is noted that the exact order of performing steps 1405, 1410 and 1415 is not critical, and that these steps can be performed in a different order, in reverse order, or simultaneously without departing from the scope of the claimed invention. It is also understood that, depending on the application, the steps of activating the suction or the closing the breach may not be necessary in any particular cycle because the suction may already be on (or never turned off), or the breach may already be closed when the object gripper is moved into place. Completing steps 1405, 1410 and 1415 using the apparatus herein described and claimed, produces the pressure gradient force about the area of the contact having sufficient magnitude to pin the object against the intake and support the object in a gravitation field. Next, at step 1420, the body, and therefore the object gripper and the object, are moved or rotated. At step 1425, the actuating system is activated to open the breach, thereby reducing the magnitude of the pressure gradient force by an amount sufficient to release the object.

At step 1430, the system determines, such as through an image processing or vision-enabled object identification system, whether there are any more objects to be picked up. If the answer is no, then the process is terminated. If the answer is yes, however, then the system begins executing another cycle by returning to and executing steps 1410 and 1415, wherein the breach is closed again and the body and object gripper are moved so as to come into contact with the next object.

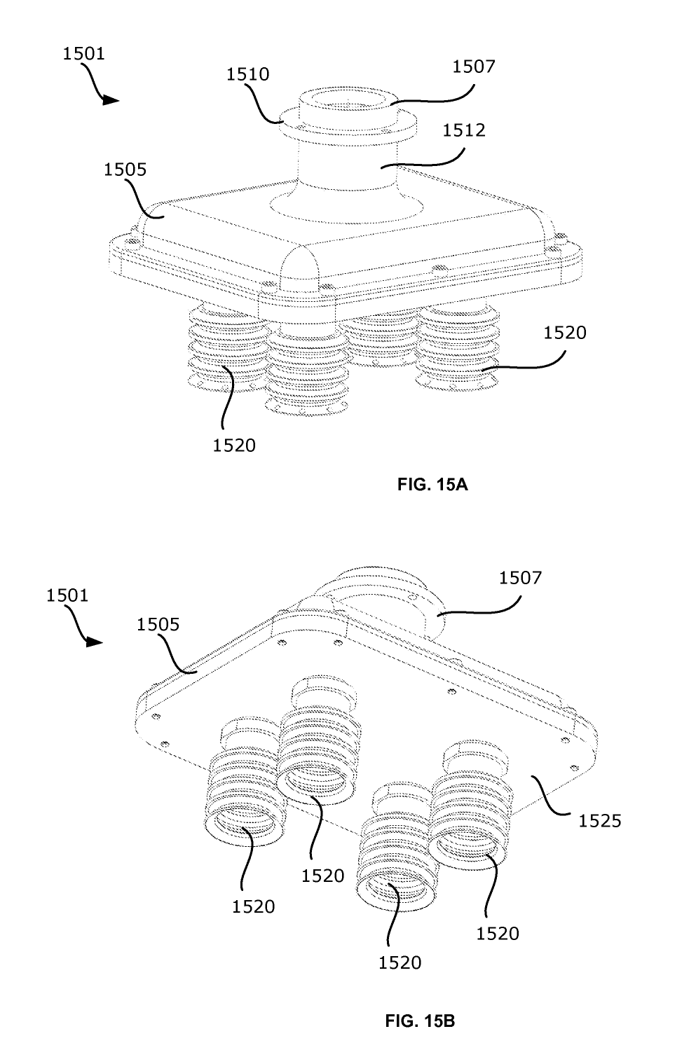

FIGS. 15A and 15B show, respectively, a right perspective view (from above) and a right perspective view (from below), of yet another type of detachable object gripper 1501, comprising a manifold adaptor 1505 and four suction pads 1520, which may be used in connection with some embodiments and variations of the present invention. This detachable object gripper may be particularly useful for picking up and releasing objects by multiple points of contact, or picking up and releasing multiple objects simultaneously. As shown in FIGS. 15A and 15B, object gripper 1501 comprises a manifold adaptor 1505 having an upper throat 1507 and a lower throat 1512. A manifold flange 1510, which is disposed about upper throat 1507, contains a number of screw holes configured to receive screws that will secure detachable object gripper 1501 to an end effector according to one embodiment of the present invention, such as end effector 100 depicted in FIGS. 1A and 1B. Thus, screws may be inserted into the bottom sides of the screw holes of manifold flange 1510 so that they pass up into a corresponding gasket on the end effector, such as gasket 112 (shown in FIG. 10A).

As shown best in FIG. 15B, four distinct suction pads 1520 are attached to the bottom side 1525 of manifold adaptor 1505 so that when suction is applied to the upper throat 1507 to pull air through manifold adaptor 1505, it will create separate and distinct pressure gradients about each one of the intakes on the bottoms of the four suction pads 1520. The four suction pads 1520 may arranged in any suitable configuration so as to come into contact with a single object (not shown), such as a liquid-filled bag, at four separate locations, which may provide more stability during picking and releasing operations than a single suction pad, depending on the geometry and contents of the object to be picked up. Alternatively, multiple objects may be picked up simultaneously by arranging the suction pads 1520 so such that they will come into contact with multiple objects in a picking operation. Although the example shown in FIGS. 15A and 15B illustrates a four pad configuration, it will be understood and appreciated that the number of suction pads attached to the manifold is not critical to the invention, and the number will vary depending, for example, on the size and geometry of the manifold adaptor and the objects to be gripped.

Although the exemplary embodiments, uses and advantages of the invention have been disclosed above with a certain degree of particularity, it will be apparent to those skilled in the art upon consideration of this specification and practice of the invention as disclosed herein that alterations and modifications can be made without departing from the spirit or the scope of the invention, which are intended to be limited only by the following claims and equivalents thereof.

1.-21. (canceled)

22. A method for gripping and releasing an object using an apparatus comprising a body, an adapter flange movably attached to the body, an object gripper, mounted to the adapter flange, said object gripper having an intake for making contact with the object, a vacuum supply port for admitting suction into the body, a substantially contiguous vacuum path that permits air passing through the intake to flow into and through the body and the vacuum supply port, and an actuating system for opening and closing a breach in the substantially contiguous vacuum path, the method comprising the steps of:
a) operating the actuating system to close the breach in the substantially contiguous vacuum path;
b) admitting suction into the body via the vacuum supply port, thereby producing about the area of the contact a pressure gradient force of sufficient magnitude to pin the object against the intake and support the object in a gravitation field; and
c) positioning the apparatus so that the intake of object gripper comes into contact with the object;
d) raising the apparatus; and
e) operating the actuating system to open the breach, thereby reducing the magnitude of said pressure gradient force by an amount sufficient to release the object.

23. The method of claim 22, further comprising:
a) attaching the apparatus to a robotic arm; and
b) using the robotic arm to lift the apparatus.

24. The method of claim 22, further comprising:
a) providing a computer system;
b) establishing an electromechanical connection between the computer system and the apparatus;
c) providing a computer-readable medium having instructions embedded therein that, when executed by the computer system causes the computer system to perform operations for lifting and releasing the object using the apparatus, the instructions comprising
i) instructions for automatically admitting suction at the vacuum supply port of the substantially contiguous vacuum path;
ii) instructions for automatically moving the object gripper so that the intake comes into contact with the object;
iii) instructions for automatically activating the actuating system to close the breach in the substantially contiguous vacuum path,
iv) instructions for automatically lifting the apparatus, and
v) instructions for automatically activating the actuating system to open the breach; and
d) executing the instructions on the computer system.

25. The method of claim 24, further comprising moving the apparatus through space.

26. The method of claim 24, further comprising rotating the apparatus in space.

27. The method of claim 23, further comprising:
a) attaching the apparatus to a vehicle; and
b) operating the vehicle to lift the apparatus.

28. An apparatus for lifting and releasing an object, comprising:
a body;
a vacuum supply port configured to admit suction into the body;
an adapter flange, movably attached to the body, for holding an object gripper, the object gripper having an intake configured to make contact with the object;
an airflow passageway configured to fluidly couple the intake to the vacuum supply port, thereby defining a substantially contiguous vacuum path that permits air passing through the intake to flow into and through the body and the vacuum supply port; and an actuating system operable to open and close a breach in the substantially contiguous vacuum path.

29. The apparatus of claim 28, wherein the breach in the substantially contiguous vacuum path is located between the object gripper and the body.

30. The apparatus of claim 28, wherein the breach in the substantially contiguous vacuum path is located between the object gripper and the adapter flange.

31. The apparatus of claim 28, wherein the breach in the substantially contiguous vacuum path is located between the adapter flange and the body.

32. The apparatus of claim 28, wherein the breach in the substantially contiguous vacuum path is located in the vacuum supply port.

33. The apparatus of claim 28, wherein said actuating system is further operable to accelerate and decelerate the object gripper in a manner that causes the object to be propelled away from the object gripper.

34. The apparatus of claim 28, wherein the actuating system comprises:
a piston cylinder disposed within the body;
a reciprocating piston slidably enclosed within said piston cylinder;
a mechanical link between the reciprocating piston and the breach;
a retracting port configured to admit fluid into one end of the piston cylinder to force the reciprocating piston toward the opposite end of the piston cylinder, which causes the mechanical link to reduce the size of the breach in the substantially contiguous vacuum path; and
e) an extending port configured to admit fluid into said opposite end of the piston cylinder to force the reciprocating piston away from said opposite end, which causes the mechanical link to expand the size of the breach in the substantially contiguous vacuum path.

35. The apparatus of claim 34, wherein said fluid is a gas.

36. The apparatus of claim 34, wherein said fluid is a liquid.

37. The apparatus of claim 34, wherein the mechanical link comprises a piston rod, coupled to the reciprocating piston, configured to urge the adapter flange toward the body responsive to activation of the retracting port, and away from the body responsive to activation of the extending port.

38. The apparatus of claim 28, further comprising a robot, attached to the body, configured to move the body through space.

39. The apparatus of claim 38, further comprising:
a computer system;
an electromechanical connection between the computer system and the robot; and
a computer-readable medium having a program stored thereon, the program having instructions that, when executed by the computer system, will cause the computer system to send a signal to the robot, via the electromechanical connection, to lift the body.

40. The apparatus of claim 39, wherein said program stored on the computer-readable medium further instructions that, when executed by the computer system, will the cause the computer system to automatically activate the actuating system.

41. The apparatus of claim 40, wherein:
the computer system comprises an object position detection system configured to detect a position for said object; and
the program further includes instructions configured to automatically send a signal to said robot that causes said robot to move said body so as to bring said object gripper into contact with said object at the detected position.

42. The apparatus of claim 28, further comprising a vehicle configured to lift the body.

43. The apparatus of claim 28, wherein, when the breach is closed, the substantially contiguous vacuum path is further configured to permit air passing out of the object gripper to flow directly into the body without passing through an internal region of the adapter flange.

44. (canceled)

45. The method of claim 22, further comprising attaching the apparatus to a robot and causing the robot to lift the apparatus.

46. The method of claim 22, further comprising:
providing a computer system;
establishing an electromechanical connection between the robot and the computer system; and
executing an instruction on the computer system that automatically sends a signal to the robot via the electromechanical connection, said signal causing the robot to lift the object.

47. The method of claim 22, further comprising attaching the apparatus to a vehicle and causing the vehicle to lift the apparatus.

48. The apparatus of claim 28 wherein:
admitting the suction into the body via the vacuum supply port when the breach is closed will produce about the area of the contact a pressure gradient force of sufficient magnitude to pin the object against the intake and support the object in a gravitational field, and
operating the actuating system to open the breach will reduce the magnitude of said pressure gradient force by an amount sufficient to release the object.
